(19) United States
(12) Patent Application Publication
(10) Pub. No.: US 2011/0181140 A1
(43) Pub. Date: Jul. 28, 2011

(54) Apparatus Having a Stator and a Rotor Mounted in Said Stator

(75) Inventor: Ernst Scherrer, Greifensee (CH)

(73) Assignee: Micronel AG, Tagelswangen (CH)

(21) Appl. No.: 12/970,453

(22) Filed: Dec. 16, 2010

(30) Foreign Application Priority Data
Jan. 22, 2010 (EP) 10 405 012.5

(51) Int. Cl. H02K 7/09

(52) U.S. Cl. 310/90.5

(57) ABSTRACT

A stator has a first bearing for a first end of a shaft of the rotor, and a second bearing for a second end of the shaft. The first and the second bearings have a respective permanent magnet which exerts a magnetic force on the shaft. Alternatively, the shaft is in the form of a permanent magnet and the first and the second bearing have a respective ferromagnetic part. At least one of the two ends of the shaft is supported axially by means of a point bearing. The apparatus is, for example, a fan.

### TECHNICAL FIELD

The present invention relates to an apparatus having a stator and a rotor which is mounted in said stator, which stator has a first bearing for a first end of a shaft of the rotor, and a second bearing for a second end of the said shaft.

### PRIOR ART

Apparatuses such as these are known, for example, as motor fans in the prior art. The two bearings for the shaft are, for example, in the form of journal bearings. The known disadvantages of such journal bearings are unavoidable wear, the increased noise that is created as a result of this, and the reduced life. According to DE-A-39 28 749, from the same applicant, a rotor can also be mounted in the stator only at one end of the shaft. However, this requires that the shaft be secured axially in the stator, which involves additional complexity and, in particular, appropriate measures during assembly.

Magnetic bearings are also known, for example according to DE-A-44 36 831 and DE-A-196 41 438. Bearings such as these require complex closed-loop control, and, in general, superconducting materials. Bearings such as these cannot be used for many applications, for example for small fans. Magnetically unloaded bearings are also known, but these are likewise unsuitable for many applications.

The invention is based on the object of providing an apparatus of the type mentioned initially which can be produced considerably more cost-effectively. The apparatus is also intended to be used for mass-produced products, such as small fans.

According to Claim 1, the object is achieved in that the first and the second bearings respectively have a permanent magnet, which exerts a magnetic force on the shaft, or the shaft is in the form of a permanent magnet and the first and the second bearings respectively have a ferromagnetic part, wherein one of the two ends of the shaft is supported axially by means of a point bearing. Thus, in the apparatus according to the invention, the rotor is supported on one side by a point bearing, with magnetic forces resulting in virtually central positioning of the rotor. Trials have shown that mass inertia forces of the rotor contribute to additional position stabilization. There is then essentially no need at all for a radial bearing. In the event of a disturbance, for example a shock, the shaft can leave the central position radially, but is then automatically returned to the central position again by magnetic forces. The two bearings can be produced very cost-effectively. All that is required is two permanent magnets. The two permanent magnets can be comparatively small, and therefore do not require any significant additional space. There is no need for axial security. Trials have shown that the apparatus according to the invention is particularly suitable in conjunction with a direct-current motor without a commutator, as has been disclosed, in particular, by CH-A-6 92 880. A direct-current motor such as this essentially exerts no radial force components, but only axial force components, on the rotor. These advantages are achieved even if the shaft is in the form of a permanent magnet, and the bearings each have a ferromagnetic part.

According to one development of the invention, only one of the two ends of the shaft is supported axially at a point, and the other end of the shaft can move freely mechanically. Friction therefore exists only in a point area at one end of the shaft. The friction forces and the wear can thus be kept minimal. The free end of the shaft is mechanically unloaded, and is subject only to the magnetic field of the corresponding permanent magnet. In particular, it has been found that a bearing such as this for a small fan with a direct-current motor without a commutator is particularly robust, and is not damaged even by comparatively severe vibration.

According to one development of the invention, at least one bearing has means for radially positively holding the shaft. Both bearings are preferably radially positively held in this way. In the event of vibration, positive holding such as this prevents unacceptable radial deflection of the shaft and/or of the rotor. After corresponding deflection, the shaft is automatically centred again by the magnetic forces. The positive holding or positive holding means therefore acts only in the event of a shock load. Positive holding can be achieved in a simple manner by a part of the bearing in the form of a collar or sleeve.

According to one development of the invention, one permanent magnet has an attracting effect on the shaft, and the other permanent magnet has a repelling effect on the shaft. The shaft rests at a point on the attracting permanent magnet. On the repelling side, the shaft can then preferably move freely mechanically, and/or is at a distance from the repelling permanent magnet. This distance may be very small, for example a few hundredths of a millimetre. The shaft can be produced very cost-effectively from a ferromagnetic material. An embodiment is also feasible in which both permanent magnets have an attracting effect on the shaft. In this case, one permanent magnet preferably has a greater attraction force than the other permanent magnet.

The shaft can rest directly at a point on one of the two permanent magnets. However, in this case, indirect bearing is also feasible, for example with the shaft being borne on a friction-reducing coating which is arranged in one permanent magnet. Polyamide, preferably a plastic and/or a polyamide which contains molybdenum, is particularly suitable as the material for a coating such as this.

If the shaft is in the form of a permanent magnet, then the centring of the shaft is particularly robust if at least one ferromagnetic part is curved towards the shaft.

Further advantageous features result from the dependent claims, from the following description and from the drawing.

Exemplary embodiments of the invention will be explained in more detail in the following text with reference to the drawing, in which:

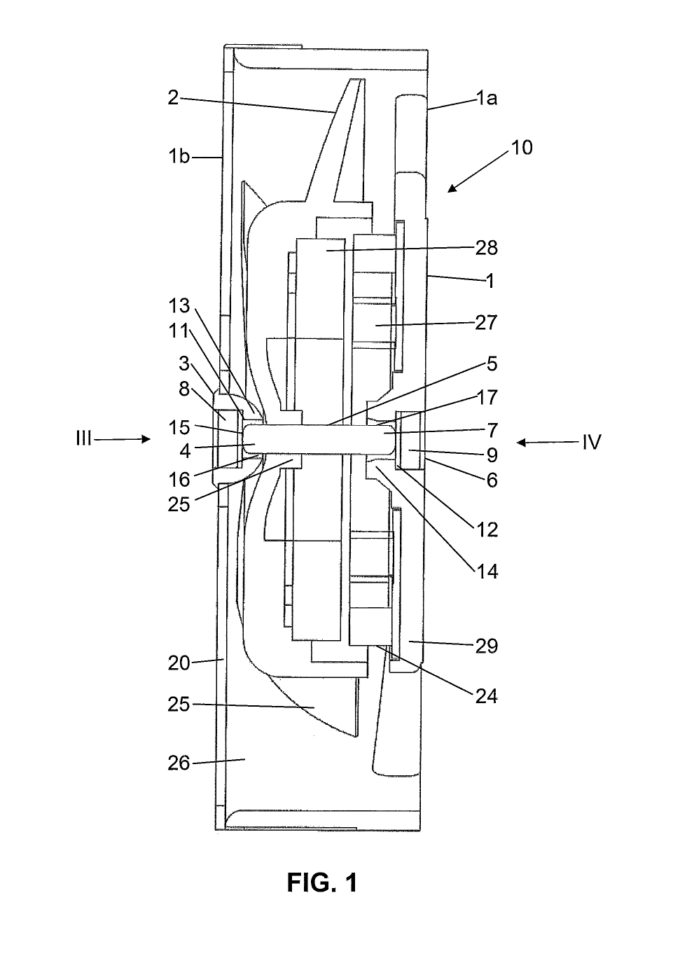

FIG. 1 schematically illustrates a section through an apparatus according to the invention,

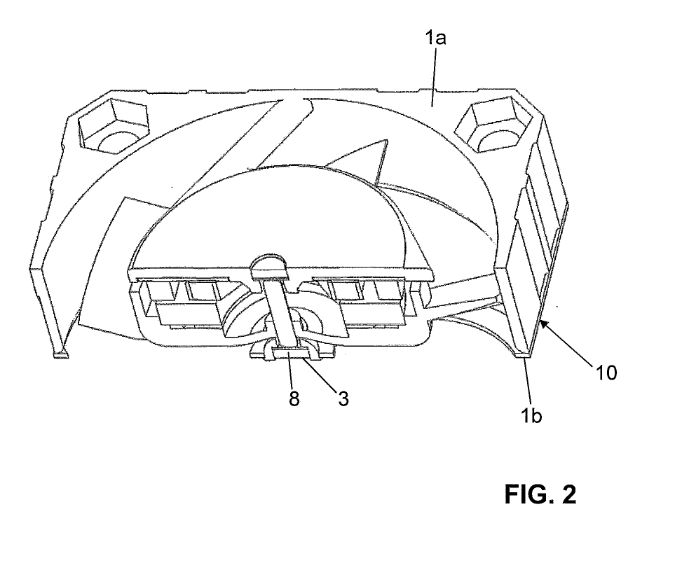

FIG. 2 schematically illustrates a three-dimensional view of an axially sectioned apparatus as shown in FIG. 1,

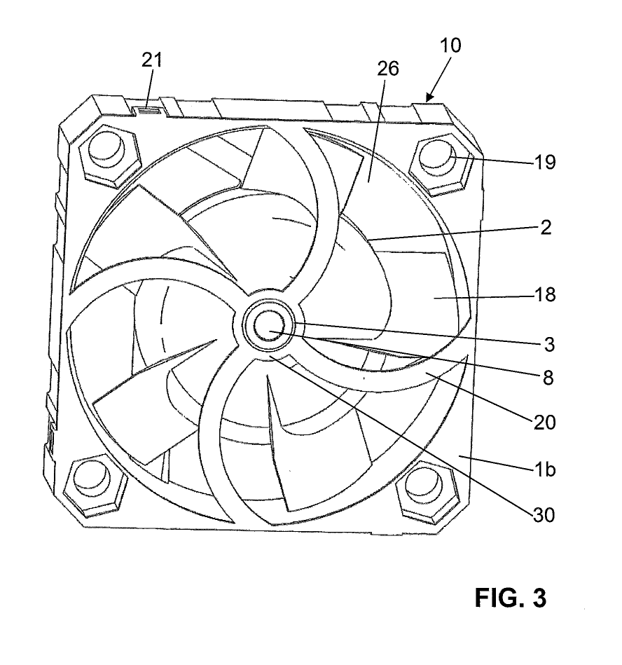

FIG. 3 shows a view of the apparatus according to the invention, in the direction of the arrow III in FIG. 1,

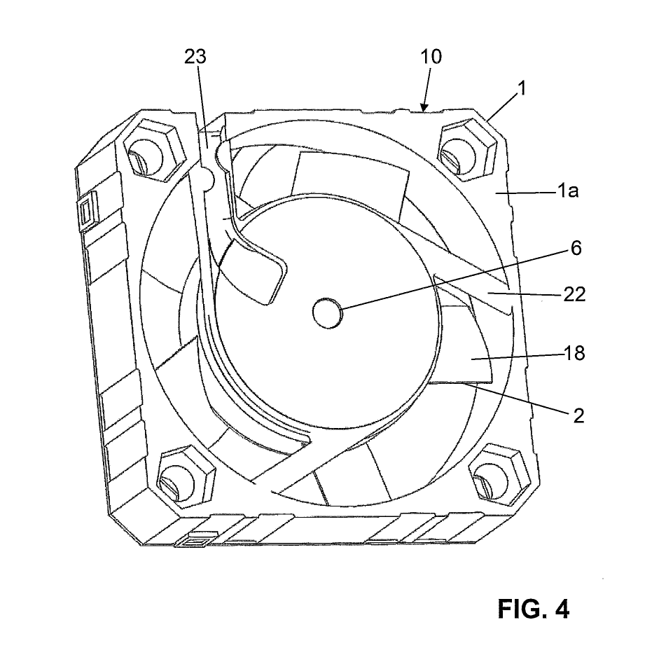

FIG. 4 shows a schematic three-dimensional view of the apparatus according to the invention, in the direction of the arrow IV in FIG. 1, and

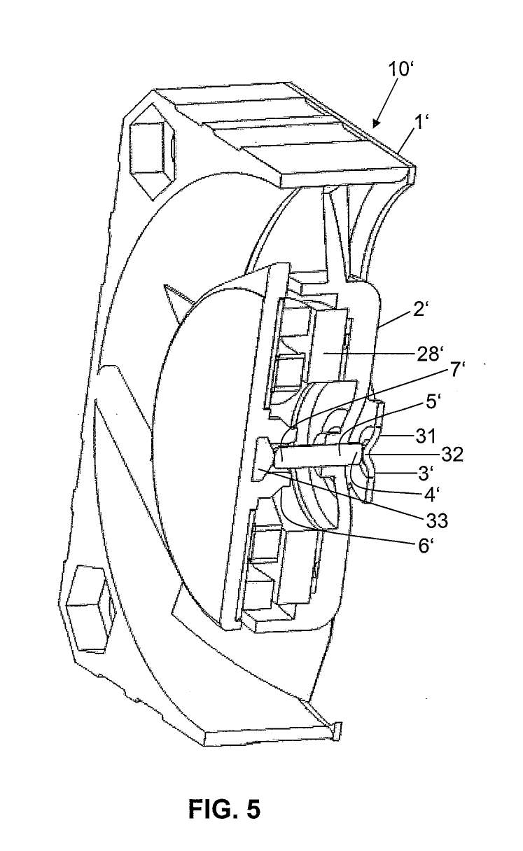

FIG. 5 shows a three-dimensional view of one variant of an axially sectioned apparatus.

The apparatus 10 forms a fan, and in particular a small fan, which has a stator 1 in which the rotor 2 is mounted. The stator 1 consists of two stator parts 1a and 1b which, as shown in FIG. 3, are detachably connected to one another by means of latching tongues 21. In this case, as can be seen, the stator part 1a is rectangular and in the form of a box, while the stator part 1b is essentially flat and in the form of a plate. In order to allow flow to pass through the stator 1 in the axial direction when the rotor 2 is rotating, the two stator parts 1a and 1b are open, as a result of which they form a passage 26. This allows air to flow from right to left in FIG. 1 when the rotor 2 is rotating.

The stator part 1a has a bearing plate 29 centrally, which is connected via webs 22 to the part of the stator part 1a which is in the form of a frame. A coil 27 and control elements, which are not shown in any more detail, for a direct-current motor without a commutator are arranged on one side of this bearing plate 29. The coil 27 interacts with an annular magnet 28, which is connected to the rotor 2. The direct-current motor without a commutator can be designed according to CH-A-692 880. However, some other suitable motor is also feasible here. As shown in FIG. 3, the stator part 1b likewise has a plurality of webs 10, which are connected to one another centrally via a ring 30. A first bearing 30 is mounted on this ring 30. The bearing 30 has an annular first holder 13 in which a first permanent magnet 8 is mounted. The first holder 13 is inserted into the ring 30 and is attached to it, for example by latching means which are not shown here. The permanent magnet 8 is firmly connected to the first holder 13. A second bearing 6 is formed by a second permanent magnet 9 and a second holder 14. This second holder 14 is a part of the bearing plate 29. The second permanent magnet 9 is firmly connected to this second holder 14 and to the bearing plate 29. The permanent magnet 9 and the second holder 14 form a second bearing 6.

The two bearings 3 and 6 are used to bear a shaft 5 of the rotor 2. This shaft 5 is firmly connected to the rotor 2 via a flange 25, and has a first end 4 and a second end 7. In this case, the first end 4 is considerably shorter than the second end 7. The shaft 5 is composed of a ferromagnetic material, and is attracted at least by the first permanent magnet 8 in the axial direction. The second permanent magnet 9 can be designed such that a repelling effect is exerted on the second end 7 and on the shaft 5. An embodiment is also possible in which the second permanent magnet 9 has an attracting effect on the shaft 5, but the attracting force is considerably less than that of the first permanent magnet 8. The shaft 5 is therefore pulled against the first permanent magnet 8 and rests on it at a point, at a contact point 15. As can be seen, the first end 14 is correspondingly curved. On the side on which the shaft 5 rests on the first permanent magnet 8, the permanent magnet 8 is provided with a coating 11 over its area, which is produced from a low-friction material, for example from polyamide. The polyamide may contain molybdenum, in order to keep the frictional resistance as low as possible. However, an embodiment is also feasible in which the first end 4 rests directly on the permanent magnet 8. As shown, the permanent magnet 8 may be provided with a coating 11 on both sides. During assembly, the permanent magnet 8 can then be inserted in both orientations. As can be seen, the first end 4 is comparatively short. The flange 25 is therefore at a comparatively short distance away from the first permanent magnet 8. In any case, the distance is several times less than the distance to the second permanent magnet 9. That surface of the coating 11 on which the shaft 5 rests is preferably planar, although a surface which is not planar is also feasible.

There is an annular intermediate space 16 between the first holder 13 and the first end 4. When the rotor 2 is rotated, the first holder 13 is normally not in contact. Since the first end 4 is held only by the magnetic force of the first permanent magnet 8, this first end 4 can be deflected radially when there is a severe shock load on the apparatus 10. This radial deflection is limited by the first holder 13. The first end 4 therefore cannot leave the magnetic field of the first permanent magnet 8, and is in each case centred again by this field after a load such as this. The second holder 14 has a corresponding function for the second end 7. The corresponding intermediate space is in this case provided with the reference symbol 17. There may be a shorter distance between the second end 7 and the permanent magnet 9, which is likewise provided with a coating 12. The end 7 may, however, also rest elastically on the second permanent magnet 9. This elastic force, which is comparatively small, can be exerted by the webs 20 of the stator part 1b. In this case, the contact between the second end 7 and the second permanent magnet 9 is likewise in the form of a point.

In the motor, force is preferably introduced axially to the rotor 2. This allows the rotor 2 to be borne in a particularly robust manner. In the radial direction, the motor therefore exerts essentially no force on the rotor 2. Furthermore, when the rotor 2 is rotating, mass inertia forces assist the bearing stability.

In the illustrated exemplary embodiment, the apparatus 10 is a fan through which air flows axially. In principle, however, the apparatus 10 may also be a radial fan. Instead of air, a different medium, for example water, may, however, also flow through the apparatus 10. Finally, the apparatus 10 may, for example, be in the form of a turbine. The medium flowing through it therefore then drives the rotor 2, which produces electricity via a generator. By way of example, the apparatus 10 may be mounted fixed in an appliance. For this purpose, four apertures 19 are provided on the stator 1 and are suitable, for example, for holding attachment screws or the like, which are not shown here. In the illustrated exemplary embodiment, the rotor 2 is provided with a plurality of vanes 18. These vanes 18 may be designed differently, depending on the application.

The bearing for the apparatus 10 can be produced extremely cost-effectively. There is no need for lubricants. There is extraordinarily little friction between the rotor 2 and the stator 1. Essentially no bearing friction changes occur over a wide temperature range. Many magnets that are known per se are suitable for use as the permanent magnets 8 and 9. There is therefore no need for special magnets, and there is also no need for closed-loop control. The bearing is therefore a passive magnetic bearing.

The apparatus 10′ illustrated in FIG. 5 likewise has a stator 1′ and a rotor 2′, which has a motor with a magnet 28′. In this embodiment, however, the shaft 5′ is in the form of a permanent magnet. The bearings 3′ and 6′ respectively have a ferromagnetic part 32 or 33, on which the shaft 5′ is mounted at a point. The two parts 32 and 33 are respectively curved towards the first end 4′ and the second end 7′, as can be seen. This results in a magnetic field which centres the shaft 5′ and automatically returns it to the central position again after a disturbance.

### LIST OF REFERENCE SYMBOLS

1 Stator
1a Stator part
1b Stator part
2 Rotor
3 First bearing
4 First end
5 Shaft
6 Second bearing
7 Second end
8 First permanent magnet
9 Second permanent magnet
10 Apparatus
11 Coating
12 Coating
13 First holder
14 Second holder
15 Contact shaft
16 Intermediate space
17 Intermediate space
18 Vane
19 Apertures
20 Web
21 Latching tongue
22 Web
23 Connecting opening
24 Rotor
25 Flange
26 Passage
27 Coil
28 Magnet
29 Bearing plate
30 Ring
31 Bearing part
32 Curve
33 Bearing part

1-12. (canceled)

13. An apparatus comprising: a stator and a rotor which is mounted in said stator, which stator has a first bearing for a first end of a shaft of the rotor, and a second bearing for a second end of the said shaft, wherein the first and the second bearings respectively have a permanent magnet which exerts a magnetic force on the shaft, or the shaft is in the form of a permanent magnet and the first and the second bearings respectively have a ferromagnetic part, wherein at least one of the two ends of the shaft is supported axially by means of a point bearing.

14. The apparatus according to claim 13, wherein only one of the two ends is supported axially at a point.

15. The apparatus according to claim 13, wherein at least one of the two bearings has means for radially positively holding the shaft.

16. The apparatus according to claim 13, wherein at least one of the two permanent magnets or at least one end of the shaft has at least one friction-reducing coating.

17. The apparatus according to claim 16, wherein the coating is produced from a plastic.

18. The apparatus according to claim 17, wherein the plastic has a friction-reducing component.

19. The apparatus according to claim 13, wherein the rotor is driven by a motor.

20. The apparatus according to claim 19, wherein the motor is a direct-current motor without a commutator.

21. The apparatus according to claim 19, wherein the motor is designed such that it exerts essentially no radial force component on the rotor.

22. The apparatus according to claim 13, wherein the apparatus is a fan.

23. The apparatus according to claim 13, wherein the apparatus is in the form of a turbine.

24. The apparatus according to claim 13, wherein at least one of the two ferromagnetic parts is curved toward the shaft.

25. The apparatus according to claim 17, wherein the plastic is polyamide.

26. The apparatus according to claim 18, wherein the friction-reducing component is molybdenum.
